(19) United States
(12) Patent Application Publication
(10) Pub. No.: US 2020/0215608 A1
(43) Pub. Date: Jul. 9, 2020

(54) PRESSED POWDER MOLDED BODY MANUFACTURING METHOD

(71) Applicant: SUMITOMO ELECTRIC INDUSTRIES, LTD., Osaka-shi, Osaka (JP)

(72) Inventors: Asako WATANABE, Itami-shi (JP); Tomoyuki UENO, Itami-shi (JP)

(21) Appl. No.: 16/628,684

(22) PCT Filed: Jul. 5, 2018
(86) PCT No.: PCT/JP2018/025497

§ 371 Date: Jan. 6, 2020

(30) Foreign Application Priority Data
Jul. 10, 2017 (JP) 2017-135092

(51) Int. Cl. B22F 3/03; H01F 1/01; B22F 3/093

(52) U.S. Cl. CPC B22F 3/03; B22F 2301/35; B22F 3/093; H01F 1/015

(57) ABSTRACT

A method for producing a green compact, the method including a charging step of charging a raw-material powder including iron-based particles into a cavity formed by a lower punch and a die that are arranged to be movable relative to each other, a pressurizing step of pressurizing the raw-material powder charged in the cavity by the lower punch and an upper punch in order to form a green compact, the upper punch being arranged to face the lower punch, and a drawing step of drawing the green compact from the cavity by a relative movement between the green compact and the die. The drawing step is conducted while vibrations are applied to the green compact for at least part of the period from the time just before the relative movement starts to the time at which the relative movement completes.

### TECHNICAL FIELD

The present disclosure relates to a method for producing a green compact. The present application claims a priority to Japanese Patent Application No. 2017-135092 filed on Jul. 10, 2017, which is incorporated herein by reference in its entirety.

### BACKGROUND ART

The method for producing a green compact disclosed in PTL 1 which includes a charging step, a pressurizing step, and a drawing step is known as a method for producing a green compact in which an iron-based powder is pressurized. In the charging step, an iron-based raw-material powder is charged into a cavity formed by a lower punch and a die that are arranged to be movable relative to each other. In the pressurizing step, the raw-material powder charged in the cavity is pressurized by the lower punch and an upper punch to form a green compact, the upper punch being arranged to face the lower punch. In the drawing step, the green compact is drawn from the cavity by a relative movement between the green compact and the die. The drawing of the green compact is performed by applying vibrations having an amplitude of 3.5 μm or less to the lower punch. This reduces the frictional force between the green compact and the inner peripheral surface of the die and makes it easier to draw the green compact from the cavity. Consequently, the likelihood of scratches and the like being formed on the surface of the green compact as a result of the surface of the green compact being brought into sliding contact with the inner peripheral surface of the die can be reduced.

### CITATION LIST

### Patent Literature

PTL 1: Japanese Unexamined Patent Application Publication No. 2015-52163

### SUMMARY OF INVENTION

A method for producing a green compact according to the present disclosure includes:

a step of charging a raw-material powder including iron-based particles into a cavity, the cavity being formed by a lower punch and a die that are arranged to be movable relative to each other;

a step of pressurizing the raw-material powder charged in the cavity by the lower punch and an upper punch in order to form a green compact, the upper punch being arranged to face the lower punch; and

a step of drawing the green compact from the cavity by a relative movement between the green compact and the die.

The step of drawing the green compact from the cavity is conducted while vibrations are applied to the green compact for at least part of the period from the time just before the relative movement starts to the time at which the relative movement completes.

The application of the vibrations is done by vibrating the lower punch at an amplitude of 3.6 μm or more.

### BRIEF DESCRIPTION OF DRAWINGS

FIG. 1A is a schematic diagram illustrating a charging step included in a method for producing a green compact according to Embodiment 1.

FIG. 1B is a schematic diagram illustrating a pressurizing step included in a method for producing a green compact according to Embodiment 1.

FIG. 1C is a schematic diagram illustrating a drawing step included in a method for producing a green compact according to Embodiment 1.

FIG. 2A is a schematic front view of an amplitude measuring apparatus used for measuring the amplitude of vibration of a green compact in Test example 1.

FIG. 2B is a cross-sectional view taken along the cutting-plane line (b)-(b) illustrated in FIG. 2A.

FIG. 3 is a graph illustrating the relationships between the amplitude of vibration of a lower punch and a maximum drawing pressure which were determined in Sample Nos. 4-1 to 4-6.

### DESCRIPTION OF EMBODIMENTS

### Problems to be Solved by Present Disclosure

A further reduction in the frictional force between a green compact and the inner peripheral surface of a die is anticipated.

Accordingly, it is an object to provide a method for producing a green compact, the method enabling a significant reduction in the frictional force that acts between a green compact and the inner peripheral surface of a die when the green compact is drawn from a metal mold.

### Advantageous Effects of Present Disclosure

The method for producing a green compact according to the present disclosure enables a significant reduction in the frictional force that acts between a green compact and the inner peripheral surface of a die when the green compact is drawn from a metal mold.

### DESCRIPTION OF EMBODIMENT

The inventors of the present invention conducted extensive studies of a further reduction in the frictional force that acts between a green compact and the inner peripheral surface of a die when the green compact is drawn from the cavity. As a result, it was found that the frictional force between a green compact and the inner peripheral surface of a die can be markedly reduced when the amplitude of vibration of a lower punch is limited to fall within a specific range.

The present disclosure was made on the basis of the above finding. First, the aspects of the present disclosure are listed below.

(1) A method for producing a green compact according to an aspect of the present disclosure includes:

a step of charging a raw-material powder including iron-based particles into a cavity, the cavity being formed by a lower punch and a die that are arranged to be movable relative to each other;

a step of pressurizing the raw-material powder charged in the cavity by the lower punch and an upper punch in order to form a green compact, the upper punch being arranged to face the lower punch; and

a step of drawing the green compact from the cavity by a relative movement between the green compact and the die.

The step of drawing the green compact from the cavity is conducted while vibrations are applied to the green compact for at least part of the period from the time just before the relative movement starts to the time at which the relative movement completes.

The application of the vibrations is done by vibrating the lower punch at an amplitude of 3.6 μm or more.

The above-described production method enables a significant reduction in the frictional force that acts between the green compact and the inner peripheral surface of the die when the green compact is drawn from the cavity. This is because limiting the amplitude of vibration of the lower punch to be 3.6 μm or more in the step of drawing the green compact from the cavity enables the green compact to vibrate in an effective manner and consequently makes it easy to draw the green compact from the cavity.

Furthermore, the significant reduction in frictional force leads to a reduction in the likelihood of scratches being formed on the surface of the green compact as a result of the surface of the green compact being brought into sliding contact with the inner peripheral surface of the die, a reduction in the likelihood of metal particles constituting the green compact adhering onto the inner peripheral surface of the die, and a reduction in the likelihood of scratches being formed on the surface of the green compact as a result of the surface of the green compact being brought into sliding contact with the metal particles adhered.

The significant reduction in frictional force also leads to a reduction in the load placed on the metal mold and consequently increases the service life of the metal mold.

(2) In a method for producing a green compact according to another aspect of the present disclosure, the application of the vibrations is done such that the amplitude of vibration of the lower punch is synchronized with the amplitude of vibration of the green compact.

This production method enables the significant reduction in frictional force in a further effective manner.

(3) In a method for producing a green compact according to still another aspect of the present disclosure, the amplitude of vibration of the lower punch is 15.0 μm or less.

In this production method, the magnitude of the vibrations applied to the green compact is not excessively large and the likelihood of the green compact becoming damaged by the vibrations can be reduced.

### DETAILS OF EMBODIMENTS

Details of the embodiment are described below with reference to the attached drawings.

### Embodiment 1

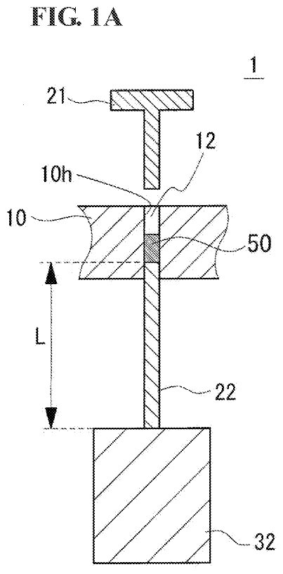

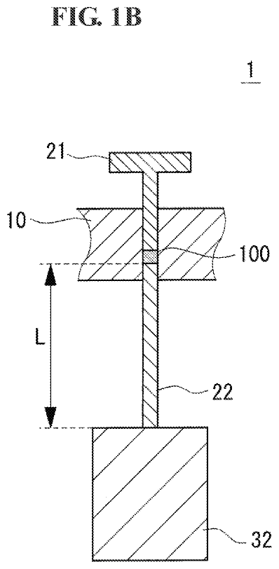

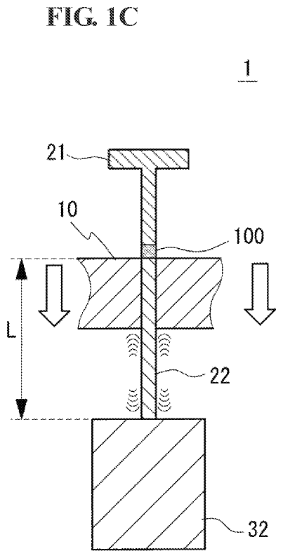

A method for producing a green compact according to Embodiment 1 is described below with reference to FIGS. 1A, 1B, and 1C. The method for producing a green compact includes a step of charging a raw-material powder 50 into a cavity 12 as illustrated in FIG. 1A (hereinafter, this step may be referred to as “charging step”), a step of pressurizing the raw-material powder 50 charged in the cavity 12 by an upper punch 21 and a lower punch 22 in order to form a green compact 100 as illustrated in FIG. 1B (hereinafter, this step may be referred to as “pressurizing step”), and a step of drawing the green compact 100 from the cavity 12 as illustrated in FIG. 1C (hereinafter, this step may be referred to as “drawing step”). In the drawing step, vibrations are applied to the green compact 100 by vibrating the lower punch 22. One of the features of the method for producing a green compact is that, in the drawing step, the amplitude of vibration of the lower punch 22 (hereinafter, this amplitude may be referred to simply as “amplitude”) is limited to fall within a specific range. Hereinafter, an example of a metal mold 1 used in the method for producing a green compact according to the embodiment is described. Subsequently, the steps included in the production method are described. In FIGS. 1A, 1B, and IC, a die 10, an upper punch 21, a lower punch 22, and a vibration unit 32 are illustrated in a cross-sectional view for the sake of simplicity.

### [Metal Mold]

The metal mold 1 includes a tubular die 10 having a through-hole 10h formed therein; a pair of punches, that is, an upper punch 21 and a lower punch 22, that can be inserted into and drawn from the through-hole 10h; and a vibration unit 32 that causes the lower punch 22 to vibrate. The upper punch 21 and the lower punch 22 are arranged to face each other inside the through-hole 10h. In the metal mold 1, the upper surface of the lower punch 22 and the inner peripheral surface of the die 10 form a cavity 12 (i.e., a molding space) with a bottom. A columnar green compact 100 is produced by charging the raw-material powder 50 described below into the cavity 12 and pressurizing and compressing the raw-material powder 50 using the upper punch 21 and the lower punch 22. Subsequently, the green compact 100 is drawn from the die 10. In the case where a tubular green compact 100 is prepared, the metal mold 1 may further include a columnar core rod (not illustrated in the drawings) that is inserted inside the upper punch 21 and the lower punch 22 and forms the inner peripheral surface of the green compact 100. In this example, the lower punch 22 is fixed to a main-body apparatus with the vibration unit 32 interposed therebetween, and the die 10 and the upper punch 21 are configured to be vertically movable with a moving mechanism that is not illustrated in the drawings. Alternatively, the die 10 may be fixed in position, while the upper punch 21 and the lower punch 22 are configured to be movable. In another case, all of the die 10, the upper punch 21, and the lower punch 22 may be configured to be movable.

(Die, Upper Punch, and Lower Punch)

A surface of the upper punch 21 and a surface of the lower punch 22 which face each other form the end surfaces of the green compact 100. The inner peripheral surface of the die 10 forms the side surface of the green compact 100. The shape of the through-hole 10h and the shape of the pressurizing surfaces of the upper punch 21 and the lower punch 22 can be selected appropriately in accordance with the shape of the green compact. In this example, the shape of the through-hole 10h and the shape of the pressurizing surfaces of the upper punch 21 and the lower punch 22 are circular. The materials constituting the die 10, the upper punch 21, and the lower punch 22 may be any high-strength materials that have been used for forming a green compact of a metal material. For example, sintered hard alloys and high-speed steels may be used.

The length L of the lower punch 22 in the direction in which the lower punch 22 vibrates may be selected appropriately. The length L of the lower punch 22 is particularly preferably, for example, an integral multiple of the half-wavelength of vibration of the lower punch 22. In such a case, the resonance of the lower punch 22 can occur, and it becomes possible to apply vibrations to the green compact 100 in an effective manner. The half-wavelength varies with the type of material constituting the lower punch 22. Accordingly, it is preferable to adjust the length L of the lower punch 22 to be an integral multiple of the half-wavelength in accordance with the frequency at which the lower punch 22 is vibrated in the production process described below. Specifically, for example, in the case where the lower punch 22 is composed of a high-speed steel, the half-wavelength is about 2800 mm at a frequency of 1 kHz, and the length L of the lower punch 22 may be 2800 mm×n (n=1, 2, 3, . . . ). Similarly, at a frequency of 20 kHz, the half-wavelength is about 140 mm and the length L of the lower punch 22 may be 140 mm×n. At a frequency of 40 kHz, the half-wavelength is about 70 mm and the length L of the lower punch 22 may be 70 mm×n. At a frequency of 100 kHz, the half-wavelength is about 28 mm and the length L of the lower punch 22 may be 28 mm×n.

(Vibration Unit)

The vibration unit 32 causes the lower punch 22 to vibrate. Vibrations are applied to the green compact 100 by vibrating the lower punch 22. The vibration unit 32 is arranged to, for example, be joined to the lower punch 22. More specifically, the vibration unit 32 is joined to the lower end of the lower punch 22. This enables the lower punch 22 to vibrate in the direction in which the green compact 100 and the die 10 move relative to each other (i.e., the direction in which the lower punch 22 extends). That is, the direction in which the lower punch 22 vibrates is the same as the direction in which a pressure is applied by the upper punch 21 and the lower punch 22. The vibration unit 32 is fixed to a main-body apparatus that is not illustrated in the drawings. The type of the vibration unit 32 is not limited and may be any vibration unit capable of causing the lower punch 22 to vibrate at the predetermined frequency and amplitude described below in order to apply vibrations to the green compact 100. The vibration unit 32 may be, for example, a commercial vibration unit. The predetermined frequency, amplitude, etc. are described in Production Process below.

Details of the specific process for producing the green compact 100 using the metal mold 1 are described below. Hereinafter, a preparation step, a charging step, a pressurizing step, and a drawing step are described in this order.

### [Production Process]

(Preparation Step)

A raw-material powder 50 for the green compact 100 is prepared. The raw-material powder 50 includes iron-based particles. The term “iron-based particles” used herein refers to particles of pure iron (Fe: 99 mass % or more) or particles of an iron alloy that includes Fe as a principal component.

The element added to the iron alloy may be selected appropriately in accordance with the use of the green compact 100, such as a magnetic core or a general structural component (sintered compact), such as a mechanical component. The element added to the iron alloy is, for example, one or more elements selected from Ni, Cu, Cr, Mo, Mn, C, Si, Al, P, B, N, and Co. Specific examples of the iron alloy include an Fe—Si-based alloy, an Fe—Al-based alloy, an Fe—N-based alloy, an Fe—Ni-based alloy, an Fe—C-based alloy, an Fe—B-based alloy, an Fe—Co-based alloy, an Fe—P-based alloy, an Fe—Ni—Co-based alloy, an Fe—Al—Si-based alloy, a stainless steel, an Fe—C-based alloy, an Fe—Cu—Ni—Mo-based alloy, an Fe—Ni—Mo—Mn-based alloy, an Fe—P-based alloy, an Fe—Cu-based alloy, an Fe—Cu—C-based alloy, an Fe—Cu—Mo-based alloy, an Fe—Ni—Mo—Cu—C-based alloy, an Fe—Ni—Cu-based alloy, an Fe—Ni—Mo—C-based alloy, an Fe—Ni—Cr-based alloy, an Fe—Ni—Mo—Cr-based alloy, an Fe—Cr-based alloy, an Fe—Mo—Cr-based alloy, an Fe—Cr—C-based alloy, an Fe—Ni—C-based alloy, and an Fe—Mo—Mn—Cr—C-based alloy.

The average particle size of the raw-material powder 50 may be selected appropriately in accordance with the use of the green compact 100 and may be, for example, about 10 μm or more and about 500 μm or less. When the average particle size of the raw-material powder 50 is about 10 μm or more and about 500 μm or less, it becomes easy to mold the raw-material powder 50 into shape without excessively increasing compacting pressure. More specifically, in the case where the green compact 100 is used as a magnetic core, the average particle size of the raw-material powder 50 is preferably about 30 μm or more and about 300 μm or less. When the average particle size of the raw-material powder 50 is about 30 μm or more and about 300 μm or less, excellent fluidity may be achieved. In addition, it becomes possible to produce a green compact capable of reducing the hysteresis loss of a magnetic core and the eddy current loss of the magnetic core which occurs when the magnetic core is used at high frequencies. In the case where the green compact 100 is used as a general structural component, the average particle size of the raw-material powder 50 is preferably about 50 μm or more and about 300 μm or less. When the average particle size of the raw-material powder 50 is about 50 μm or more and about 300 μm or less, it becomes easy to achieve markedly high shape accuracy, markedly high dimensional accuracy, and markedly high strength simultaneously. The above average particle size is the D50 (50%) particle size (the particle size that corresponds to 50% in a mass-basis cumulative distribution curve determined using a laser diffraction particle size analyzer).

The raw-material powder 50 may be a powder constituted by only particles or a coated powder that includes coated particles constituted by particles and an insulating coating covering the surfaces of the particles. Examples of the material constituting the insulating coating include compounds including a metal element or a non-metal element; metal salt compounds; resins, such as a thermoplastic resin and a non-thermoplastic resin; and salts of higher fatty acids. Examples of the compound that includes a metal element include compounds (e.g., a metal oxide, a metal nitride, and a metal carbide) produced from one or more metal elements selected from Fe, Al, Ca, Mn, Zn, Mg, V, Cr, Y, Ba, Sr, rare-earth elements (excluding Y), and the like and one or more elements selected from oxygen, nitrogen, and carbon; zirconium compounds; and aluminum compounds. Examples of the compound that includes a non-metal element include phosphorus compounds and silicon compounds. Examples of the metal salt compounds include phosphoric acid metal salt compounds (e.g., typically, iron phosphate, manganese phosphate, zinc phosphate, and calcium phosphate); boric acid metal salt compounds; silicic acid metal salt compounds; and titanic acid metal salt compounds. Examples of the resins include polyamide-based resins and silicone resins.

The thickness of the insulating coating is, for example, 10 nm or more and 1 μm or less. When the thickness of the insulating coating is 10 nm or more, it becomes easy to provide insulation between the iron-based particles and the insulating coating works in a suitable manner. When the thickness of the insulating coating is 1 μm or less, a reduction in the proportion of the metal component in the green compact which occurs due to the presence of the coating can be limited. The thickness of the insulating coating is determined, for example, in the following manner. First, the equivalent thickness of the coating is derived on the basis of the composition of the film determined by composition analysis (analyzer that uses a transmission electron microscope and energy dispersive X-ray spectroscopy (TEM-EDX)), the contents of elements in the film which is determined with an inductively coupled plasma mass spectrometer (ICP-MS), and the specific surface area (BET specific surface area: m²/g) determined using a fluid specific surface area analyzer. Subsequently, the insulating coating is directly observed using a TEM image, and it is confirmed that the order of magnitude of the equivalent thickness falls within an appropriate range. This equivalent thickness is considered the average thickness of the insulating coating. More specifically, the TEM-EDX is, for example, JEM-2100FS produced by JEOL Ltd. The ICP-MS is, for example, Model 7700 ICP-MS produced by Agilent. The fluid specific surface area analyzer is, for example, FlowSorb III 2305 produced by Shimadzu Corporation. First, the composition of the insulating coating is measured with the TEM-EDX. Subsequently, the composition of the combination of the insulating coating and the iron-based particles is measured with the ICP-MS. Then, the specific surface area of the powder is measured with the fluid specific surface area analyzer. The equivalent thickness of the insulating coating is calculated on the basis of the specific surface area of the powder, the composition of the iron-based particles, and the composition of the insulating coating. Subsequently, the iron-based particles covered with the insulating coating are subjected to an FIB (focused ion beam) treatment in order to expose a cross section of the iron-based particles. The cross section of the iron-based particles is observed with a TEM. The observation is made at, for example, five points. When the order of magnitude of the equivalent thickness and the order of magnitude of the thickness of the insulting coating observed with the TEM are substantially the same as (in general, less than 10 times) each other, the equivalent thickness is considered the average thickness of the insulating coating.

The raw-material powder 50 may include a lubricant. Addition of a lubricant enhances the lubricity of the raw-material powder 50 when the raw-material powder 50 is molded into shape. Examples of the lubricant include metal soaps, such as zinc stearate and lithium stearate; fatty acid amides, such as stearamide; higher fatty acid amides, such as ethylene bis stearamide; and inorganic substances, such as boron nitride and graphite. The amount of the lubricant added to the raw-material powder 50 is preferably about 0.005% by mass or more and about 1% by mass or less relative to 100% by mass of the total amount of the powder and the lubricant. When the amount of the lubricant added to the raw-material powder 50 is about 0.005% by mass or more and about 1% by mass or less, the lubricity of the raw-material powder 50 may be readily improved to a sufficient degree by the addition of the lubricant. In addition, a reduction in the proportion of the metal component in the green compact 100 can be limited. The lubricant may be a powder or a liquid.

(Charging Step)

In the charging step, the raw-material powder 50 prepared in the preparation step is charged into a cavity 12. The cavity 12 is formed by the upper surface of the lower punch 22 and the inner peripheral surface of the die 10 (i.e., the through-hole 10h) as illustrated in FIG. 1A. The upper punch 21 is moved to a predetermined standby position located above the die 10. The raw-material powder 50 is charged into the cavity 12 by using a powder feed device (not illustrated in the drawings).

(Pressurizing Step)

In the pressurizing step, the raw-material powder 50 charged in the cavity 12 is pressurized and compressed to form a green compact 100. As illustrated in FIG. 1B, the upper punch 21 is moved downward and inserted into the through-hole 10h of the die 10 in order to pressurize and compress the raw-material powder 50 with the upper punch 21 and the lower punch 22. When the raw-material powder 50 is pressurized and compressed, after the upper punch 21 has come into contact with the raw-material powder 50, only the upper punch 21 may be moved downward. The die 10 may also be moved downward as well as the upper punch 21. Moving the die 10 as well as the upper punch 21 makes it easy to press the raw-material powder 50 at a uniform pressure with the upper punch 21 and the lower punch 22. Furthermore, in the case where the raw-material powder 50 includes the coated powder, the likelihood of the insulating coating becoming damaged as a result of an excessive movement of the raw-material powder 50 may be reduced. This is because the amount of movement of portions of the raw-material powder 50 charged in the cavity 12 which are in contact with the upper punch 21 or present in the vicinity of the upper punch 21 toward the lower punch 22 can be reduced.

The compacting pressure can be selected appropriately in accordance with the use of the green compact 100. In the case where the green compact 100 is used as a magnetic core, the compacting pressure may be set to, for example, 290 MPa or more and 1500 MPa or less. When the compacting pressure is 290 MPa or more, the raw-material powder 50 can be compressed to a sufficient degree, and the relative density of the green compact 100 can be increased. When the compacting pressure is 1500 MPa or less, even in the case where the raw-material powder 50 includes the coated powder, the damage to the coating can be reduced. Furthermore, it becomes possible to mold the raw-material powder 50 into shape without significantly degrading the service life of the metal mold 1. The compacting pressure is particularly preferably 500 MPa or more and 1300 MPa or less. In the case where the green compact 100 is used as a general structural component, the compacting pressure may be set to, for example, 300 MPa or more and 1000 MPa or less.

(Drawing Step)

In the drawing step, the green compact 100 is drawn from the cavity 12. The drawing of the green compact 100 is done by moving the die 10 relative to the green compact 100 as illustrated in FIG. 1C.

As a result of the relative movement of the die 10, at least a part of the green compact 100 is exposed from the cavity 12 such that the green compact 100 can be drawn from the cavity 12. For example, the die 10 is moved relatively until the level of the upper surface of the lower punch 22 becomes equal to or higher than that of the upper surface of the die 10. When at least a part of the green compact 100 is exposed from the cavity 12 as illustrated in FIG. 1C, the green compact 100 can be drawn from the cavity 12 with a manipulator or the like. In this example, the green compact 100 is not moved and only the die 10 is moved downward. In the example illustrated in FIG. 1C, the die 10 is moved while the green compact 100 is sandwiched between the lower surface of the upper punch 21 and the upper surface of the lower punch 22. The upper punch 21 may be moved upward before the die 10 is moved. The upper punch 21 may be moved upward at the same time as the die 10 is moved.

The green compact 100 is drawn from the cavity 12 while vibrations are applied to the green compact 100. In this example, the application of vibrations to the green compact 100 is done by vibrating the lower punch 22 with a vibration unit 32 joined to the lower punch 22. The direction in which vibrations are applied is, for example, the direction in which the green compact 100 and the die 10 are moved relative to each other, that is, the direction of the length L of the lower punch 22. In such a case, the frictional force that acts between the green compact 100 and the inner peripheral surface of the die 10 when the green compact 100 is drawn from the die 10 can be reduced and, consequently, the green compact 100 can be readily drawn from the die 10.

the amplitude of vibration of the lower punch 22 is, for example, 3.6 μm or more. When the amplitude of the lower punch is 3.6 μm or more, large vibrations can be applied to the green compact 100 and, consequently, the above-described frictional force can be markedly reduced. The upper limit for the amplitude of the lower punch 22 is preferably 15.0 μm or less. When the amplitude of the lower punch 22 is 15.0 μm or less, the magnitude of the vibrations applied to the green compact 100 is not excessively increased and, consequently, the damage to the green compact 100 by the vibrations can be reduced. In addition, an excessive increase in the size of the vibration unit 32 can be prevented. The amplitude of the lower punch 22 is particularly preferably 3.6 μm or more and 10.0 μm or less. The amplitude of the lower punch 22 is preferably smaller than the D10 (10%) particle size (the particle size that corresponds to 10% in a mass-basis cumulative distribution curve) of the raw-material powder 50. When the amplitude of the lower punch 22 is smaller than the D10 (10%) particle size of the raw-material powder 50, the frictional force can be reduced in a more effective manner. This is because, if a large amount of particles smaller than the amplitude of the lower punch 22 are present, the reduction in the frictional force may be limited. Note that, in the present disclosure, the amplitude of vibration of the lower punch 22 is measured while no load is applied to the lower punch 22.

The application of vibrations to the green compact 100 is preferably done such that the amplitude of vibration of the lower punch 22 is synchronized with the amplitude of vibration of the green compact 100. That is, it is preferable that the vibration unit 32 causes the lower punch 22 to vibrate such that the amplitude of vibration of the lower punch 22 is synchronized with the amplitude of vibration of the green compact 100. When the amplitude of vibration of the lower punch 22 is synchronized with the amplitude of vibration of the green compact 100, the above-described frictional force can be markedly reduced. It is considered that the amplitude of vibration of the lower punch 22 is synchronized with the amplitude of vibration of the green compact 100 in the case where the amplitude of vibration of the lower punch 22 is substantially equal to the amplitude of vibration of the green compact 100 with consideration of allowable measurement error, the amplitude of vibration of the green compact 100 is described in Test examples below.

The frequency of vibration of the lower punch 22 is preferably 1 kHz or more and 100 kHz or less. When the frequency of vibration of the lower punch 22 is 1 kHz or more, a number of vibrations can be applied to the green compact 100 and, consequently, the above-described frictional force can be reduced. When the frequency of the vibration of the lower punch 22 is 100 kHz or less, the number of vibrations applied to the green compact 100 is not increased excessively and, consequently, the damage to the green compact 100 due to excessive vibration can be prevented. The frequency of vibration of the lower punch 22 is more preferably within ultrasonic frequencies, that is, for example, 10 kHz or more and 60 kHz or less and is particularly preferably 25 kHz or more and 50 kHz or less.

The frequency of vibration of the lower punch 22 is preferably selected appropriately within the range of 1 kHz or more and 100 kHz or less in accordance with the length L of the lower punch 22. Specifically, the frequency of vibration of the lower punch 22 may be set to, for example, the frequency at which resonance of the lower punch 22 occurs. When the frequency of vibration of the lower punch 22 is set to the frequency at which resonance of the lower punch 22 occurs, vibrations that effectively reduce the frictional force can be applied to the green compact 100. More specifically, the frequency of vibration of the lower punch 22 may be selected such that an integral multiple of the half-wavelength of vibration of the lower punch 22 is equal to the length L of the lower punch 22 in the direction in which the lower punch 22 is vibrated. Since the half-wavelength varies with the material constituting the member that is to be vibrated (in this example, the lower punch 22) as described above, the frequency of vibration of the lower punch 22 may be selected appropriately in accordance with the type of the material constituting the lower punch 22.

The application of vibrations to the green compact 100 is continued for at least part of the period from the time just before the relative movement between the green compact 100 and the die 10 starts (hereinafter, referred to simply as “the time just before the movement”) to the time at which the drawing of the green compact 100 completes. The time just before the movement is the time just before the application of the drawing pressure (at the same time as the application of the drawing pressure). The time at which the drawing of the green compact 100 completes is the time at which the entirety of the green compact 100 becomes exposed from the cavity 12. The drawing pressure is the pressure applied to at least one of the green compact 100 and the die 10 when the green compact 100 and the die 10 are moved relative to each other. In the case where a pressure is applied to both of the green compact 100 and the die 10, the total of the pressures is considered the drawing pressure. For example, in the case where a pressure is applied both of the green compact 100 and the die 10 and the time at which a pressure is applied to the green compact 100 is different from that at which a pressure is applied to the die 10, the earlier of the two times is considered the time at which the drawing pressure is applied.

The time at which the application of vibrations to the green compact 100 is started is preferably after the predetermined pressurizing has been performed in the pressurizing step and just before the movement. The frictional force between the green compact 100 and the inner peripheral surface of the die 10 (i.e., the drawing pressure) reaches the maximum when the movement is started and gradually decreases with the relative movement between the green compact 100 and the die 10. Accordingly, when vibrations are applied to the green compact 100 just before the movement, the frictional force (i.e., the drawing pressure) can be reduced and, consequently, it becomes easy to draw the green compact 100 from the cavity 12. Therefore, the application of vibrations to the green compact 100 is preferably continued from the time just before the movement to the time at which the green compact 100 is being drawn from the cavity and is particularly preferably continued from the time just before the movement to the time at which the drawing of the green compact 100 completes.

In the case where vibrations are applied to the green compact 100 from the time just before the movement of the green compact 100 to the time at which the green compact 100 is being drawn from the cavity, the frictional force increases when the application of vibrations is stopped. Therefore, it is preferable to continue the application of vibrations until the frictional force is reduced to a sufficient level. Specifically, it is preferable to continue the application of vibrations until at least one of the following conditions are satisfied: the drawing pressure is reduced to 10% or less of the initial peak drawing pressure; and the distance of the relative movement between the green compact 100 and the die 10 is 10% or more of the entire length of the green compact 100.

In the case where vibrations are applied to the green compact 100 from the time just before the movement of the green compact 100 to the time at which the drawing of the green compact 100 completes, the frictional force can be reduced all over the period during which the green compact 100 is drawn and the green compact 100 can be drawn from the die 10 readily compared with the case where the vibration is stopped when the green compact 100 is being drawn from the cavity. In such a case, after the green compact 100 has been exposed from the die 10, it is preferable to stop the application of vibrations to the green compact 100 before the green compact 100 is removed with a manipulator or the like. Stopping the application of vibrations to the green compact 100 before the green compact 100 is removed eliminates the risk of the green compact 100 becoming damaged due to vibration when the green compact 100 is grabbed with a manipulator or the like.

The charging step, the pressurizing step, and the drawing step may be repeatedly conducted. That is, after the green compact 100 has been removed from the metal mold 1, the cavity 12 is formed and, subsequently, the above-described three steps, that is, charging of the raw-material powder 50 into the cavity 12 (i.e., the charging step), pressurizing of the raw-material powder 50 (i.e., the pressurizing step), and the drawing of the green compact 100 (i.e., the drawing step), are repeatedly conducted in order to form another green compact 100. Repeatedly conducting the charging step, the pressurizing step, and the drawing step enables efficient mass production of the green compact 100.

### [Applications]

The method for producing a green compact according to Embodiment 1 may be suitably used for producing a green compact that can be used as a magnetic core for various coil components (e.g., a reactor, a transformer, a motor, a choking coil, an antenna, a fuel injector, and an ignition coil) or as a material for the magnetic core. The method for producing a green compact according to Embodiment 1 may also be suitably used for producing a green compact that can be used as any general structural component (e.g., a sintered component, such as a machine component, such as a carrier, an oil pump rotor, a pulley, a sprocket, a ring, or a flange) or as a material for the general structural component.

The method for producing a green compact according to the embodiment has the following advantages.

(1) In the drawing step, the frictional force that acts between the green compact 100 and the inner peripheral surface of the die 10 when the green compact 100 is drawn from the cavity 12 can be markedly reduced. This is because applying vibrations to the green compact 100 by applying vibrations having an amplitude of 3.6 μm or more to the lower punch 22 in the drawing step enables the green compact to vibrate in an effective manner and consequently makes it easy to draw the green compact 100 from the cavity 12.

(2) Furthermore, the significant reduction in frictional force leads to a reduction in the likelihood of scratches being formed on the surface of the green compact 100 as a result of the surface of the green compact 100) being brought into sliding contact with the inner peripheral surface of the die 10, a reduction in the likelihood of metal particles constituting the green compact 100 adhering onto the inner peripheral surface of the die 10, and a reduction in the likelihood of scratches being formed on the surface of the green compact 100 as a result of the surface of the green compact 100 being brought into sliding contact with the metal particles adhered. In particular, in the case where the raw-material powder 50 includes soft magnetic particles constituted by particles and an insulating coating disposed on the surfaces of the particles, the expansion of the particles can be limited and, consequently, the risk of the particles being brought into conduction with one another due to the damage to the insulating coating can be reduced. Accordingly, in the case where the green compact 100 is used as a magnetic core for a coil component and the coil is energized, an increase in eddy current loss can be limited. Thus, it is possible to produce a green compact 100 with which a coil component having excellent magnetic properties can be produced.

(3) The significant reduction in frictional force also leads to a reduction in the load placed on the metal mold 1 and consequently increases the service life of the metal mold 1.

### Test Example 1

A green compact was prepared. The drawing pressure was measured as an index for the frictional force that acted between the green compact and the inner peripheral surface of a die when the green compact was drawn from the die.

In the production of the green compact, the die 10, the upper punch 21, the lower punch 22, and the vibration unit 32 as illustrated in FIG. 1A and a precision universal testing machine (AG-100kNX produced by Shimadzu Corporation) that is not illustrated in the drawings were used. The vibration unit 32 was joined to the lower end of the lower punch 22. The direction in which the vibration unit 32 was vibrated was adjusted to be the same as the direction in which the green compact 100 and the die 10 were moved relative to each other. The shape of the through-hole 10h formed in the die 10 and the shape of the pressurizing surfaces of the upper punch 21 and the lower punch 22 were circular. The diameter of the pressurizing surface of the lower punch 22 was 10.3 mm. The length L of the lower punch 22 was 140 mm.

### [Sample Nos. 1-1 to 1-6]

The green compacts 100 of Sample Nos. 1-1 to 1-6 were prepared as in the method for producing a green compact according to Embodiment 1 above, that is, through the preparation and charging step, the pressurizing step, and the drawing step.

[Charging Step]

As a raw-material powder 50, a mixed powder produced by mixing a commercial pure iron powder having an insulating coating composed of iron phosphate with stearamide that served as a lubricant such that the proportion of the lubricant to the entire raw-material powder was 0.3% by mass was prepared. The average particle sizes D50 and D10 of the pure iron powder were about 200 μm and about 130 μm, respectively. The average thickness of the insulating coating was about 20 μm. The lower punch 22 was inserted into the through-hole 10h of the die 10 as illustrated in FIG. 1A. A cavity 12 was formed by the upper surface of the lower punch 22 and the inner peripheral surface of the through-hole 10h of the die 10. The raw-material powder 50 was charged into the cavity 12.

[Pressurizing Step]

In the pressurizing step, as illustrated in FIG. 1B, the raw-material powder 50 charged in the cavity 12 was pressurized by the upper punch 21 to form a cylindrical green compact 100 having a diameter of 10.3 mm and a height of 5 mm. In this example, the raw-material powder 50 was pressurized and compressed with a precision universal testing machine. The compression speed of the upper punch 21 was set to 50 mm/min. Subsequently, when a predetermined pressure was reached, the application of pressure was stopped. The compacting pressure was set to 294 MPa.

[Drawing Step]

In the drawing step, the green compact 100 was drawn from the cavity 12. First, the upper punch 21 was moved upward in order to draw the upper punch 21 from the through-hole 10h of the die 10. Subsequently, while vibrations were applied to the green compact 100 by vibrating the lower punch 22 with the vibration unit 32, the die 10 was moved toward the lower punch 22 at a drawing speed of 50 mm/min with a precision universal testing machine.

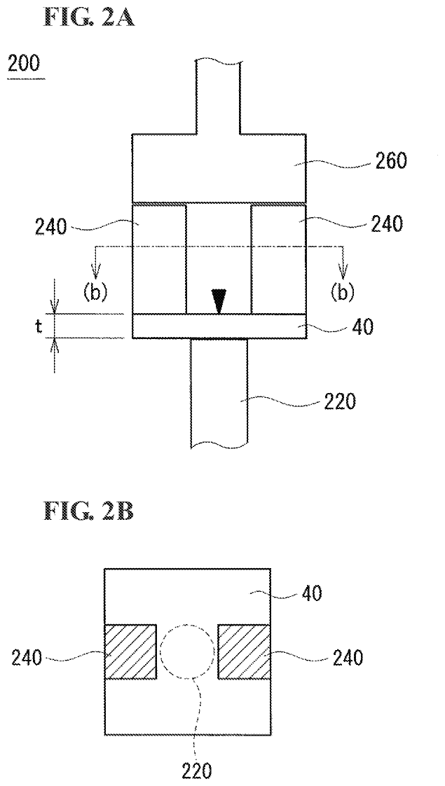

The conditions under which vibrations were applied to the lower punch 22 were as follows: frequency: 40 kHz, half-wavelength: 70 mm, the amplitude of vibration of the lower punch 22 was changed as described in Table 1. The conditions under which vibrations were applied to the lower punch 22 are configurable by the vibration unit 32, the amplitude of vibration of the green compact 100 was determined by simulation by the method described below using the member 40 corresponding to a sample and the amplitude measuring apparatus 200 illustrated in FIG. 2. Table 1 summarizes the results. The number “0” shown in the columns of amplitude in Table 1 means that vibration did not occur (the same applies in Table 2 below).

(Measurement of Amplitude of Green compact)

In the drawing step, the green compact 100 is surrounded by the lower punch 22 and the die 10 and a drawing pressure is applied to the green compact 100. In addition, it is difficult to directly measure the vibration of the green compact 100 since the green compact 100 is surrounded by the lower punch 22 and the die 10. Therefore, the member 40 corresponding to a sample and the amplitude measuring apparatus 200 illustrated in FIG. 2A were used to simulate a green compact 100 to which a drawing pressure is applied. In the amplitude measuring apparatus 200, a part of the surface of the member 40 corresponding to a sample was pressed by a pair of the pressure members 240 described below in order to apply a load corresponding to the drawing pressure to the member 40 corresponding to a sample. Vibration was measured at a position within the surface of the member 40 corresponding to a sample which was not covered with a pair of the pressure members 240. The measured vibration was considered the vibration of the green compact 100.

The member 40 corresponding to a sample was a member simulating the green compact of each sample. In this example, the member 40 corresponding to a sample was a rectangular plate made of pure iron. The thickness t (FIG. 2A) of the member 40 corresponding to a sample was set to be equal to the thickness of the green compact 100 of each sample. When the member 40 corresponding to a sample was viewed in plan, the vertical length of the member 40 corresponding to a sample (the length of the member 40 measured in the vertical direction in FIG. 2B) was set to be larger than the diameter of the member 220 corresponding to a lower punch, which is described below, or the vertical length of the pressure member 240. The horizontal length of the member 40 corresponding to a sample (the length of the member 40 measured in the horizontal direction in FIG. 2B) was set to be larger than the total of the diameter of the member 220 corresponding to a lower punch and the horizontal lengths of the two pressure members 240. The mass of the member 40 corresponding to a sample is not necessarily equal to the mass of the green compact 100 of each sample, as long as it does not significantly differ from the mass of the green compact 100 of the sample. This is because the mass of the member 40 corresponding to a sample (the green compact 100) is negligibly small compared with the load applied to the member 40 corresponding to a sample.

The amplitude measuring apparatus 200 is an apparatus capable of applying vibrations to the member 40 corresponding to a sample while a predetermined load is applied to the member 40. The amplitude measuring apparatus 200 includes a vibration unit (not illustrated in the drawings), the member 220 corresponding to a lower punch, a pair of the pressure members 240, and a member 260 applying a load. The vibration unit is joined to the lower end of the member 220 corresponding to a lower punch and causes the member 220 corresponding to a lower punch to vibrate. The vibration unit 32 illustrated in FIG. 1A was used as a vibration unit. The member 220 corresponding to a lower punch supports the lower surface of the member 40 corresponding to a sample and is vibrated by the vibration unit so as to apply vibrations to the member 40 corresponding to a sample. The lower punch 22 illustrated in FIG. 1A was used as a member 220 corresponding to a lower punch. The bottom surfaces of a pair of the pressure members 240 press the upper surface of the member 40 corresponding to a sample toward the member 220 corresponding to a lower punch. The positions at which the member 40 corresponding to a sample was pressed by the pressure member 240 were selected within the region of the upper surface of the member 40 corresponding to a sample which did not overlap the member 220 corresponding to a lower punch and were on the left and right sides of the overlapping region as illustrated in FIG. 2B. The member 260 applying a load presses the upper surfaces of a pair of the pressure members 240 and applies a predetermined load to the member 40 corresponding to a sample with a pair of the pressure members 240 interposed therebetween.

The load applied to the member 40 corresponding to a sample was set to a load corresponding to the drawing pressure (i.e., the drawing pressure measured in Sample No. 1-1) required to draw the green compact 100 from the cavity 12 without applying vibrations to the lower punch 22 in FIG. 1C. The conditions (i.e., frequency, half-wavelength, and amplitude) under which vibrations were applied to the member 220 corresponding to a lower punch were the same as those under which vibrations were applied to the lower punch 22 in a corresponding one of Sample Nos. 1-2 to 1-6. The vibration of the upper surface of the member 40 corresponding to a sample was measured and considered the amplitude of vibration of a corresponding one of the green compacts 100 of Sample Nos. 1-2 to 1-6. The position at which vibration was measured was selected within a region of the upper surface of the member 40 corresponding to a sample which overlapped the member 220 corresponding to a lower punch and is denoted by “filled triangle” in the upper diagram of FIG. 2. The vibration was measured with a commercial laser displacement gage (SI-F10 produced by Keyence Corporation).

(Measurement of Drawing Pressure)

In the drawing step, the drawing pressure was measured. The pressure applied to the die 10 when the die 10 was pressed downward was considered the drawing pressure. In this example, fluctuations in the drawing pressure which occurred until the entirety of the green compact 100 was completely exposed from the cavity 12 were measured using a precision universal testing machine. Table 1 summarizes the maximum drawing pressure (MPa). The lower the maximum drawing pressure, the smaller the frictional force between the green compact 100 and the inner peripheral surface of the die 10.

(Measurement of Density and Relative Density)

The actual density (g/cm³) and relative density (%) of the green compact 100 were measured. Table 1 summarizes the results. The actual density of the green compact 100 was determined by the Archimedes method. The relative density of the green compact 100 was calculated using “(Actual density/True density)×100”. The true density of the green compact 100 was calculated on the basis of the true densities of the iron powder used and the lubricant used and the mixing ratio therebetween.

### [Sample Nos. 2-1 to 2-6]

The green compacts 100 of Sample Nos. 2-1 to 2-6 were prepared as in Sample Nos. 1-1 to 1-6, respectively, except that the height of the green compacts 100 was changed to 10 mm as described in Table 1.

### [Sample No. 3 Series, Sample No. 4 Series, Sample No. 5 Series, and Sample No. 6 Series]

The green compacts 100 of Sample Nos. 3-1 to 3-6. Sample Nos. 4-1 to 4-6, Sample Nos. 5-1 to 5-6, and Sample Nos. 6-1 to 6-6 were prepared as in Sample Nos. 1-1 to 1-6, respectively, except that the compacting pressure was changed to 490, 686, 882, or 980 MPa as described in Table 1.

[Sample Nos. 7-1 to 7-6]

The green compacts 100 of Sample Nos. 7-1 to 7-6 were prepared as in Sample Nos. 1-1 to 1-6, respectively, except that the content of the lubricant was changed to 0.1% by mass and the compacting pressure was changed to 980 MPa as described in Table 2.

[Sample Nos. 8-1 to 8-6]

The green compacts 100 of Sample Nos. 8-1 to 8-6 were prepared as in Sample Nos. 1-1 to 1-6, respectively, except that a raw-material powder 50 different from that used in Sample Nos. 1-1 to 1-6 was used and the compacting pressure was changed to 686 MPa. As a raw-material powder 50, a mixed power produced by mixing a commercial pure iron powder having an insulating coating composed of iron phosphate with zinc stearate that served as a lubricant such that the proportion of the lubricant to the entire raw-material powder was 0.6% by mass as described in Table 2 was prepared. The average particle size D50 of the pure iron powder was about 60 μm (D10: 30 μm). The average thickness of the insulating coating was about 50 nm.

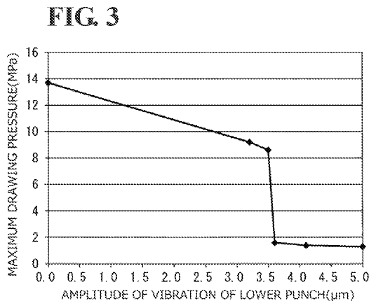

Table 1 summarizes the amplitude and maximum drawing pressure of each of the green compacts 100 of Sample Nos. 2-1 to 2-6, Sample Nos. 3-1 to 3-6, Sample Nos. 4-1 to 4-6. Sample Nos. 5-1 to 5-6, and Sample Nos. 6-1 to 6-6. Table 2 summarizes the amplitude and maximum drawing pressure of each of the green compacts 100 of Sample Nos. 7-1 to 7-6 and Sample Nos. 8-1 to 8-6. The amplitude and maximum drawing pressure of each of the green compacts 100 were determined as in Sample Nos. 1-1 to 1-6. FIG. 3 is a graph illustrating, as a typical example, the relationship between the amplitude (μm) of vibration of the lower punch 22 and the maximum drawing pressure (MPa) determined in Sample Nos. 4-1 to 4-6.

In the graph illustrated in FIG. 3, the horizontal axis shows the amplitude (μm) of vibration of the lower punch 22, while the vertical axis shows the maximum drawing pressure (MPa).

TABLE 1

| | Content of | Compacting | | | Relative |
|---|---|---|---|---|---|
| Sample | lubricant | pressure | Height | Density | density |
| No. | (mass %) | (MPa) | (mm) | (g/cm³) | (%) |
| 1-1 | 0.3 | 294 | 5 | 6.5 | 84 |
| 1-2 | 0.3 | 294 | 5 | 6.5 | 84 |
| 1-3 | 0.3 | 294 | 5 | 6.5 | 84 |
| 1-4 | 0.3 | 294 | 5 | 6.5 | 84 |
| 1-5 | 0.3 | 294 | 5 | 6.5 | 84 |
| 1-6 | 0.3 | 294 | 5 | 6.5 | 84 |
| 2-1 | 0.3 | 294 | 10 | 6.5 | 84 |
| 2-2 | 0.3 | 294 | 10 | 6.5 | 84 |
| 2-3 | 0.3 | 294 | 10 | 6.5 | 84 |
| 2-4 | 0.3 | 294 | 10 | 6.5 | 84 |
| 2-5 | 0.3 | 294 | 10 | 6.5 | 84 |
| 2-6 | 0.3 | 294 | 10 | 6.5 | 84 |
| 3-1 | 0.3 | 490 | 5 | 7.1 | 91 |
| 3-2 | 0.3 | 490 | 5 | 7.1 | 91 |
| 3-3 | 0.3 | 490 | 5 | 7.1 | 91 |
| 3-4 | 0.3 | 490 | 5 | 7.1 | 91 |
| 3-5 | 0.3 | 490 | 5 | 7.1 | 91 |
| 3-6 | 0.3 | 490 | 5 | 7.1 | 91 |
| 4-1 | 0.3 | 686 | 5 | 7.4 | 95 |
| 4-2 | 0.3 | 686 | 5 | 7.4 | 95 |
| 4-3 | 0.3 | 686 | 5 | 7.4 | 95 |
| 4-4 | 0.3 | 686 | 5 | 7.4 | 95 |
| 4-5 | 0.3 | 686 | 5 | 7.4 | 95 |
| 4-6 | 0.3 | 686 | 5 | 7.4 | 95 |
| 5-1 | 0.3 | 882 | 5 | 7.45 | 96 |
| 5-2 | 0.3 | 882 | 5 | 7.45 | 96 |
| 5-3 | 0.3 | 882 | 5 | 7.45 | 96 |
| 5-4 | 0.3 | 882 | 5 | 7.45 | 96 |
| 5-5 | 0.3 | 882 | 5 | 7.45 | 96 |
| 5-6 | 0.3 | 882 | 5 | 7.45 | 96 |
| 6-1 | 0.3 | 980 | 5 | 7.5 | 96 |
| 6-2 | 0.3 | 980 | 5 | 7.5 | 96 |
| 6-3 | 0.3 | 980 | 5 | 7.5 | 96 |
| 6-4 | 0.3 | 980 | 5 | 7.5 | 96 |
| 6-5 | 0.3 | 980 | 5 | 7.5 | 96 |
| 6-6 | 0.3 | 980 | 5 | 7.5 | 96 |

| | Amplitude of | Amplitude of | Maximum |
|---|---|---|---|
| Sample | lower punch | powder compact | drawing pressure |
| No. | (μm) | (μm) | (MPa) |
| 1-1 | 0 | 0 | 6.0 |
| 1-2 | 2.3 | 0.6 | 4.1 |
| 1-3 | 3.5 | 0.8 | 3.3 |
| 1-4 | 3.6 | 3.6 | 0.8 |
| 1-5 | 4.1 | 4.1 | 0.6 |
| 1-6 | 5.0 | 5.0 | 0.6 |
| 2-1 | 0 | 0 | 6.1 |
| 2-2 | 2.3 | 0.7 | 4.3 |
| 2-3 | 3.5 | 0.9 | 3.4 |
| 2-4 | 3.6 | 3.6 | 0.7 |
| 2-5 | 4.1 | 4.1 | 0.8 |
| 2-6 | 5.0 | 5.0 | 0.7 |
| 3-1 | 0 | 0 | 10.3 |
| 3-2 | 2.3 | 0.7 | 8.0 |
| 3-3 | 3.5 | 0.8 | 7.2 |
| 3-4 | 3.6 | 3.6 | 1.3 |
| 3-5 | 4.1 | 4.1 | 1.2 |
| 3-6 | 5.0 | 5.0 | 1.2 |
| 4-1 | 0 | 0 | 13.7 |
| 4-2 | 3.2 | 0.8 | 9.2 |
| 4-3 | 3.5 | 0.9 | 8.6 |
| 4-4 | 3.6 | 3.6 | 1.6 |
| 4-5 | 4.1 | 4.1 | 1.4 |
| 4-6 | 5.0 | 5.0 | 1.3 |
| 5-1 | 0 | 0 | 13.2 |
| 5-2 | 2.3 | 0.5 | 9.3 |
| 5-3 | 3.5 | 0.6 | 8.4 |
| 5-4 | 3.6 | 3.6 | 1.5 |
| 5-5 | 4.1 | 4.1 | 1.6 |
| 5-6 | 5.0 | 5.0 | 1.4 |
| 6-1 | 0 | 0 | 12.4 |
| 6-2 | 2.3 | 0.7 | 8.6 |
| 6-3 | 3.5 | 0.7 | 7.8 |
| 6-4 | 3.6 | 3.6 | 1.8 |
| 6-5 | 4.1 | 4.1 | 1.7 |
| 6-6 | 5.0 | 5.0 | 1.6 |

TABLE 2

| | Content of | Compacting | | | Relative |
|---|---|---|---|---|---|
| Sample | lubricant | pressure | Height | Density | density |
| No. | (mass %) | (MPa) | (mm) | (g/cm³) | (%) |
| 7-1 | 0.1 | 980 | 5 | 7.6 | 98 |
| 7-2 | 0.1 | 980 | 5 | 7.6 | 98 |
| 7-3 | 0.1 | 980 | 5 | 7.6 | 98 |
| 7-4 | 0.1 | 980 | 5 | 7.6 | 98 |
| 7-5 | 0.1 | 980 | 5 | 7.6 | 98 |
| 7-6 | 0.1 | 980 | 5 | 7.6 | 98 |
| 8-1 | 0.6 | 686 | 5 | 7.2 | 93 |
| 8-2 | 0.6 | 686 | 5 | 7.2 | 93 |
| 8-3 | 0.6 | 686 | 5 | 7.2 | 93 |
| 8-4 | 0.6 | 686 | 5 | 7.2 | 93 |
| 8-5 | 0.6 | 686 | 5 | 7.2 | 93 |
| 8-6 | 0.6 | 686 | 5 | 7.2 | 93 |

| | Amplitude of | Amplitude of | Maximum |
|---|---|---|---|
| Sample | lower punch | powder compact | drawing pressure |
| No. | (μm) | (μm) | (MPa) |
| 7-1 | 0 | 0 | 40< |
| 7-2 | 2.3 | 0.8 | 40< |
| 7-3 | 3.5 | 0.9 | 40< |
| 7-4 | 3.6 | 3.6 | 1.9 |
| 7-5 | 4.1 | 4.1 | 1.7 |
| 7-6 | 5.0 | 5.0 | 1.6 |
| 8-1 | 0 | 0 | 11.0 |
| 8-2 | 2.3 | 0.6 | 9.5 |
| 8-3 | 3.5 | 0.7 | 8.3 |
| 8-4 | 3.6 | 3.6 | 1.7 |
| 8-5 | 4.1 | 4.1 | 1.5 |
| 8-6 | 5.0 | 5.0 | 1.5 |

The results described in Tables 1 and 2 confirm that the samples prepared while the amplitude of vibration of the lower punch 22 was set to 3.6 μm or more had a markedly low maximum drawing pressure compared with the samples prepared while the amplitude was set to 3.5 μm or less. The results illustrated in FIG. 3 confirm that the maximum drawing pressure suddenly changed (i.e., decreased) when the amplitude of vibration of the lower punch 22 increased from 3.5 μm to 3.6 μm.

### APPENDICES

In relation to the foregoing embodiment of the present disclosure, the following appendices are further disclosed.

### Appendix 1

A method for producing a green compact, the method including:

a step of charging a raw-material powder including iron-based particles into a cavity, the cavity being formed by a lower punch and a die that are arranged to be movable relative to each other;

a step of pressurizing the raw-material powder charged in the cavity by the lower punch and an upper punch in order to form a green compact, the upper punch being arranged to face the lower punch; and

a step of drawing the green compact from the cavity by a relative movement between the green compact and the die.

wherein the step of drawing the green compact from the cavity is conducted while vibrations are applied to the green compact for at least part of the period from the time just before the relative movement starts to the time at which the relative movement completes, and

the application of the vibrations is done such that the amplitude of vibration of the lower punch is synchronized with the amplitude of vibration of the green compact.

The production method according to Appendix 1 enables a significant reduction in the frictional force that acts between the green compact and the inner peripheral surface of a die when the green compact is drawn from the cavity. This is because synchronizing the amplitude of vibration of the lower punch with the amplitude of vibration of the green compact in the step of drawing the green compact from the cavity enables the green compact to vibrate in an effective manner and consequently makes it easy to draw the green compact from the cavity. Furthermore, the significant reduction in frictional force leads to a reduction in the likelihood of scratches being formed on the surface of the green compact as a result of the surface of the green compact being brought into sliding contact with the inner peripheral surface of the die, a reduction in the likelihood of metal particles constituting the green compact adhering onto the inner peripheral surface of the die, and a reduction in the likelihood of scratches being formed on the surface of the green compact as a result of the surface of the green compact being brought into sliding contact with the metal particles adhered. The significant reduction in frictional force also leads to a reduction in the load placed on the metal mold and consequently increases the service life of the metal mold.

### Appendix 2

The method for producing a green compact according to Appendix 1, wherein the amplitude of vibration of the lower punch is 3.6 μm or more.

The production method according to Appendix 2 enables the significant reduction in frictional force in a further effective manner.

### Appendix 3

The method for producing a green compact according to Appendix 2, wherein the amplitude of vibration of the lower punch is 15.0 μm or less.

In the production method according to Appendix 3, the magnitude of vibrations applied to the green compact is not excessively large and the likelihood of the green compact becoming damaged by the vibrations can be reduced.

It is to be understood that the embodiment disclosed herein is illustrative and not restrictive in all aspects. It is intended that the scope of the present invention is not limited by the embodiment described above, is defined by the claims, and includes equivalents of the claims and all modifications within the scope of the claims.

### REFERENCE SIGNS LIST

1 METAL MOLD
10 DIE
10h THROUGH-HOLE
12 CAVITY
21 UPPER PUNCH
22 LOWER PUNCH
32 VIBRATION UNIT
100 GREEN COMPACT
50 RAW-MATERIAL POWDER
40 MEMBER CORRESPONDING TO SAMPLE
200 AMPLITUDE MEASURING APPARATUS
220 MEMBER CORRESPONDING TO LOWER PUNCH
240 PRESSURE MEMBER
260 MEMBER APPLYING LOAD

1. A method for producing a green compact, the method comprising:
charging a raw-material powder that includes iron-based particles into a cavity, the cavity being formed by a lower punch and a die that are arranged to be movable relative to each other;
pressurizing the raw-material powder charged in the cavity by the lower punch and an upper punch in order to form a green compact, the upper punch being arranged to face the lower punch; and
drawing the green compact from the cavity by a relative movement between the green compact and the die,
wherein the drawing the green compact from the cavity includes exposing the green compact to vibration for at least part of a period of time from just before the relative movement starts to when the relative movement is completed, and
the exposing includes vibrating the lower punch at an amplitude of 3.6 μm or more.

2. The method for producing a green compact according to claim 1, wherein the vibrating includes synchronizing the amplitude of vibration of the lower punch with an amplitude of vibration of the green compact.

3. The method for producing a green compact according to claim 1, wherein the vibrating includes vibrating the lower punch with the amplitude being 15.0 μm or less.

4. The method for producing a green compact according to claim 2, wherein the vibrating includes vibrating the lower punch with the amplitude being 15.0 μm or less.

5. The method for producing a green compact according to claim 1, further comprising:
forming the cavity by moving one or both of the lower punch and the die toward each other such that at a least a portion of the lower die is received in the die.

6. The method for producing a green compact according to claim 1, wherein the pressurizing includes forming the green compact.

7. A magnetic core comprising a green compact made by a method, the method comprising:
charging a raw-material powder that includes iron-based particles into a cavity, the cavity being formed by a lower punch and a die that are arranged to be movable relative to each other;
pressurizing the raw-material powder charged in the cavity by the lower punch and an upper punch in order to form the green compact with a relative density in an inclusive range of 84% through 98% and a density in an inclusive range of 6.5 g/cm³ through 7.6 g/cm³, the upper punch being arranged to face the lower punch; and
drawing the green compact from the cavity by a relative movement between the green compact and the die,
wherein the drawing the green compact from the cavity includes exposing the green compact to vibration for at least part of a period of time from just before the relative movement starts to when the relative movement is completed, and
the exposing includes vibrating the lower punch at an amplitude of 3.6 μm or more.

8. The magnetic core according to claim 7, wherein the vibrating includes synchronizing the amplitude of vibration of the lower punch with an amplitude of vibration of the green compact.

9. The magnetic core according to claim 7, wherein the vibrating includes vibrating the lower punch with the amplitude being 15.0 μm or less.

10. The magnetic core according to claim 8, wherein the vibrating includes vibrating the lower punch with the amplitude being 15.0 μm or less.

11. The magnetic core according to claim 7, further comprising:
forming the cavity by moving one or both of the lower punch and the die toward each other such that at a least a portion of the lower die is received in the die.

12. The magnetic core according to claim 7, wherein the pressurizing includes forming the green compact.
